(19) United States
(12) Patent Application Publication
(10) Pub. No.: US 2001/0004408 A1
(43) Pub. Date: Jun. 21, 2001

(54) Sliding bearing with a plastic film as a running surface and method for its production

(75) Inventors: Christian Schliephack, Coppenbrugge (DE); Hans Marschhausen, Hanover (DE)

Correspondence Address: Klaus P. Stoffel, Esq., Cohen, Pontani, Lieberman & Pavane, Suite 1210, 551 Fifth Avenue, New York, NY, 10176, US

(73) Assignee: RENK Akiengesellschaft

(21) Appl. No.: 09/732,971

(22) Filed: Dec. 8, 2000

(30) Foreign Application Priority Data
Dec. 8, 1999 (DE) 199 59 199.7

(51) Int. Cl. F16C 33/02

(52) U.S. Cl. 384/276

(57) ABSTRACT

A sliding bearing with a divided running surface of plastic is provided. The plastic running surface is adhesively attached to the running surface in at least one piece by a laminate which is made of a plastic layer, at least one melting layer, and at least one metal layer.

### BACKGROUND OF THE INVENTION

1. Field of the Invention

The present invention relates to a sliding bearing with a running surface of plastic and a method for producing a sliding bearing.

2. Description of the Related Art

Thick walled, hydrodynamically lubricated bearing shells and tilting segments are currently produced with metal bearing running surfaces. These may be single metal alloy or multiple metal alloy layers.

The metals used are applied to the thick walled bearing supporting elements using known methods. Common methods include the centrifugal casting method, the stationary casting method, the build up soldering method, the flame spraying method and the sintering method. For multilayer bearing metals, electrolytic coating methods are also used.

When coating the bearing running surfaces with plastics, generally known adhesive bonding methods and sintering methods are used. In the adhesive bonding method, plastic sheets, bushings or films are adhesively attached to the metal supporting element by a suitable adhesive. The adhesive must in this case be made to be exactly appropriate for the workpieces to be bonded and must permanently withstand the operating conditions of the sliding bearing. Particular attention must be paid here to temperature resistance, fatigue strength under vibratory stress, and compensation for change in length of the metal supporting element and the plastic running surface which are related to changes in temperature.

In the sintering method, the plastic is bonded with the supporting element by the application of pressure and heat. For relatively small bearing shells, this method is used successfully.

Presently, coating of all non-planar surfaces is problematical. The previous production processes required complex devices and a cost intensive system in order to obtain a solid bond. PTFE based plastics, for which there are no suitable adhesive, present additional problems. An adequately solid adhesive bond is only possible with these plastics when laborious preliminary work and etching the PTFE layer are performed.

Thin wall bearing shells are usually coated with a plastic running surface in a planar coating method and subsequently rolled mechanically into the final form of the bearing shell and pressed into the supporting element.

The methods mentioned above are all complex and cannot be used in the case of all bearings.

### SUMMARY OF THE INVENTION

The object of the present invention is to provide a sliding bearing which is simple to produce and has a plastic bearing layer. Additionally, a further object of the present invention is to provide a versatile method for the solid bonding of a plastic layer to a bearing element.

The invention provides a simple, low-cost, divided, hydrodynamically lubricated sliding bearing running surface and a rapid method of making same.

The sliding bearings of the present invention ensure electrical insulation by a plastic sliding layer, eliminating the need for additional measures or treatment on the bearing housing or on the bearing shell. Since the layer or film coating is very thin, heat conduction from the bearing shell to the housing is simultaneously optimized.

The friction values under mixed frictional conditions are significantly lower in the present invention as compared to metallic bearing metal alloys. As a result, lower starting torques occur on the machines equipped with the sliding bearings of the present invention.

Since the thermal loading capacity of the sliding bearing running surfaces of the present invention is significantly higher than the thermal loading capacity of metallic bearing metal alloys, higher rotational speeds are possible.

In the event of damage, repair or replacement of the plastic-metal laminate of the present invention can take place in a simple, quick and economical way using a simple device.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like numbers designate similar elements throughout the several views, the present invention is shown in schematic form as follows:

FIG. 1 shows a laminate according to the present invention;

FIG. 2 shows a bearing housing having a laminate according to the present invention;

FIG. 3 shows supporting element halves configured according to the present invention;

FIG. 4 shows a device for adhesively bonding a laminate into a bearing, half; and

FIG. 5 shows a sliding shoe to which laminate is adhesively attached.

### DETAILED DESCRIPTION OF THE PRESENTLY PREFERRED EMBODIMENTS

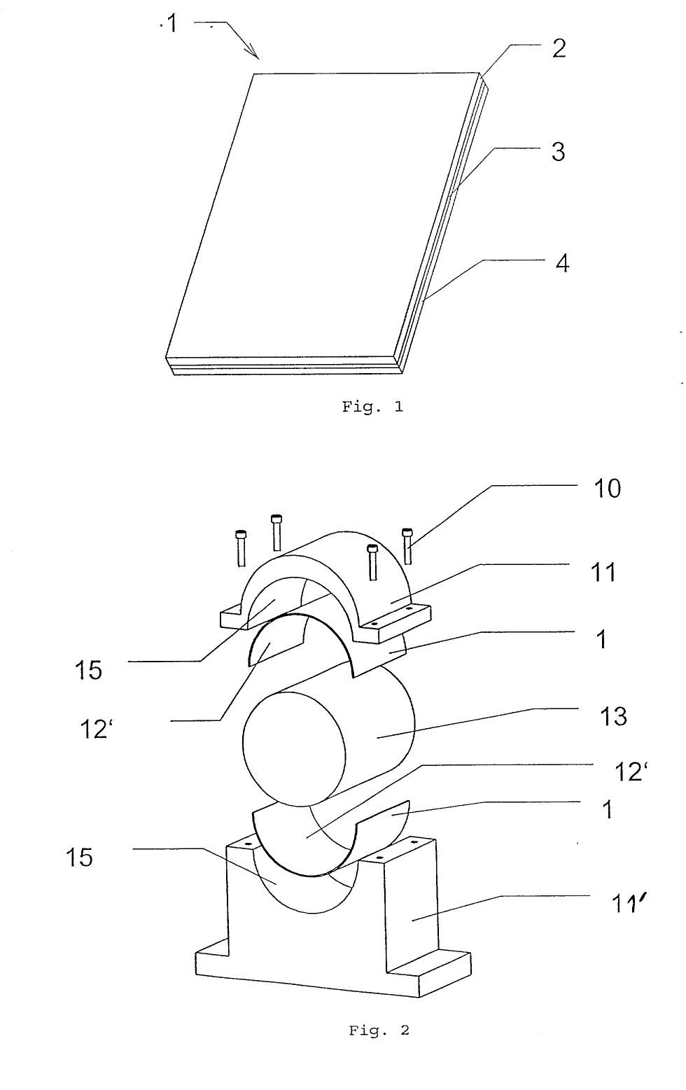

Referring now to FIG. 1, a laminate 1 is shown comprising a plastic film or layer 2, preferably of polytetrafluorethylene (PTFE). These so-called skived PTFE films are produced with a wide variety of known additives and fiber reinforcements and serve as a running surface.

The plastic film 2 is solidly bonded, preferably by a melting film 3, under high pressure and at a corresponding temperature to a further sheet or layer. This sheet is preferably a metal foil 4 or a metal mesh, the latter of which is intended to mean a thin netting of metallic material. In addition to such three-layered laminates 1, it is also possible to bond a plurality of films from a wide variety of materials to one another, in each case by a melting film 3, in one operation.

The laminate 1 produced in this way is flexible, approximately up to about 2 mm thick, and can be adhesively attached readily into a bearing bore or onto slightly curved surfaces of sliding shoes, segments, axial parts or shoulder abutment surfaces.

Although adhesive bonding is advantageous, other alternative means of fixing may likewise be used.

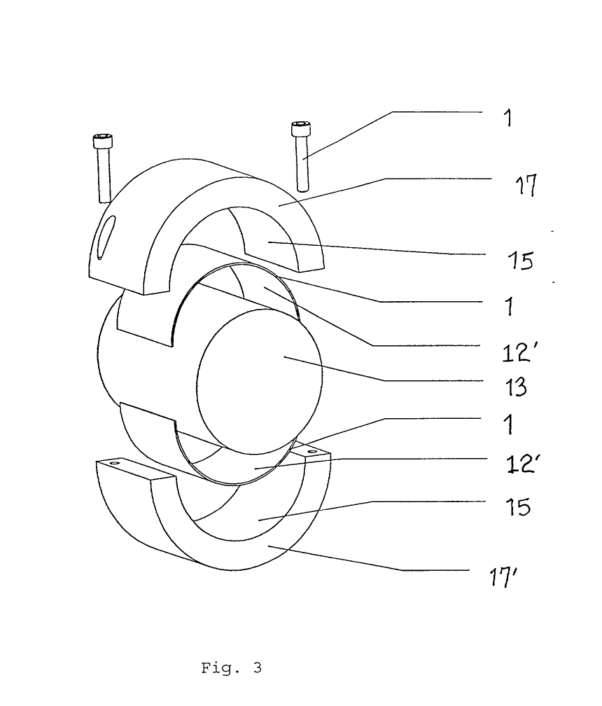

Referring now to FIG. 2, an embodiment of the present invention is shown. A bearing housing having a running surface is provided in two housing halves 11, 11′. A laminate 1 is adhesively bonded into the divided bore 15, on both the lower housing half 11′ and on the upper housing half 11. The laminate 1 may in this case be adhesively bonded into each housing half 11, 11′ as one sheet or in a plurality of pieces.

The bore 15 subjected to adhesive bonding may be circular cylindrical or else profiled, to form, for example, a multi-surface sliding bearing.

It is also possible, to form offset halves, by displacing either the bore center points of the housing halves 11, 11′ or the supporting element halves 17, 17′ subjected to adhesive bonding relative to one another.

Even in the case of laminates 1 only a few tenths of a millimeter thick, reliable electrical insulation is ensured by the layer of plastic. In addition, optimum heat dissipation from the running surface 12′, for example, into the housing halves 11, 11′ is assured.

For producing the plastic coating, individual pieces or a plurality of pieces cut to match the housing halves 11, 11′ are adhesively bonded by suitable metal adhesives, for example, two component epoxy resin adhesives, with their metal slide into the bore 15.

For fixing the laminate 1 during curing of the adhesive, a piece of shaft 13 is clamped between the housing halves 11, 11′, whereby the laminate 1 is pressed against the wall of the bore 15. This piece of shaft 13 or mold bears the form of the desired bore 15 of the sliding bearing. In the case of circular cylindrical bores 15, for example, the piece of shaft 13 has a diameter which is the same size as the shaft to be borne plus the bearing play. The bearing play is to be understood as meaning the difference between the bearing diameter or the diameter of the bore 15 and the diameter of the shaft to be borne.

In the case of multi-surface sliding bearings with spline profiles in the running surface, the piece of shaft 13 must have the corresponding mating profiles.

The two bearing halve are clamped by screwing the joints with the screws 10 provided into the associated threaded bores. It is also possible to use a clamping device, such as a hydraulic press, to press the housing halves 11, 11′ together. After curing the adhesive, clamping is discontinued and the piece of shaft 13 is removed. No further work on the form of the bore in the bearing housing halves 11, 11′ is required.

Referring now to FIG. 3, a bearing shell which comprises two supporting element halves 17, 17′, with one or more pieces of the laminate 1 as the plastic running surface 12′ is shown. Essentially, the same method as previously described, for clamping bearing housing halves 11, 11′, as shown in FIG. 2, applies for fixing the laminate 1 in the bore 15 of the supporting halves, 17, 17′.

After the adhesive bonding of the laminate 1 into the two halves of the bore 15, the various pieces are fixed by clamping a piece of shaft 13 between the supporting element halves 17, 17′. After curing the adhesive, the pressing which in this case is applied by screwing the joint or by a clamping device, is discontinued. The plastic running surface 12′ is ready for use without any further subsequent work.

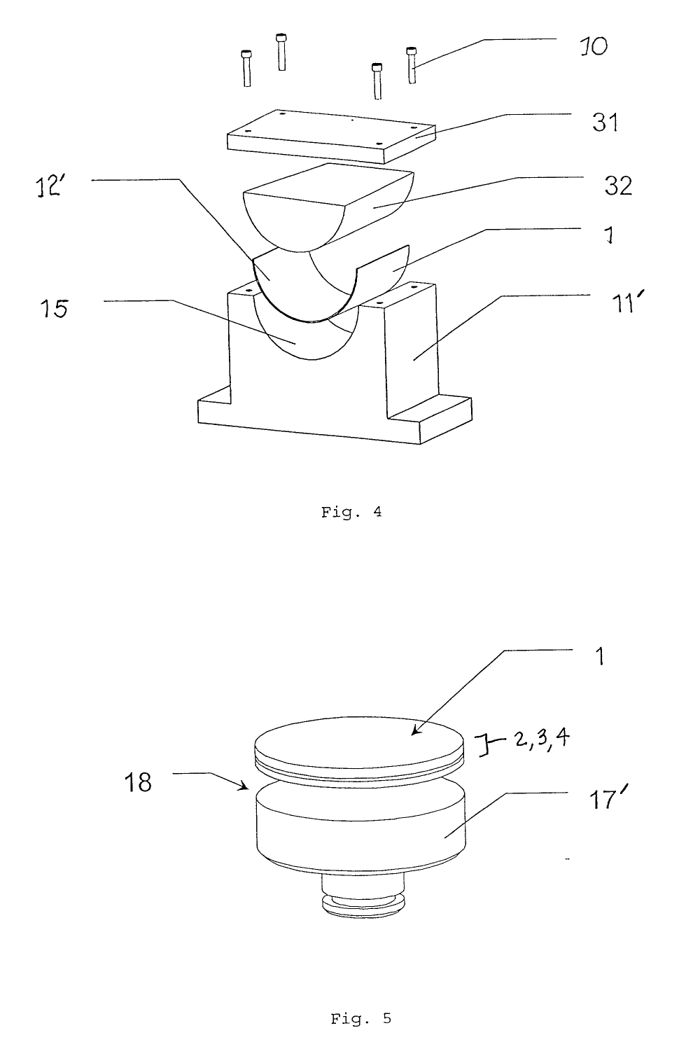

Referring now to FIG. 4, an alternative method of applying the laminate 1 is shown. The laminate 1 adhesively bonded into the housing half 11′ is fixed during setting of the adhesive by a half shaft 32, which is pressed into the bore 15 by means of a plate 31. The plate 31 can be fitted on the housing half 11′ using screws 10 inserted through the plate 31 and into the housing half 11′ via threaded bores provided for this purpose.

In this embodiment, the half shaft 32 is a piece of shaft which is flattened in the longitudinal direction to form a half cylinder with the bore 15 being filled up to the joint. The diameter of the basic cylinder is the diameter of the shaft to be borne in addition to the bearing play.

In a modification of this embodiment, profiling may be provided on the circumferential surface of the basic cylindrical form, in order to produce multi-surface sliding bearings or other forms of bore, in the manner as described previously regarding the shaft 13.

In FIG. 4, the device 31, 32 is represented on a lower housing half 11 but may also be used on an upper housing half 11 or on a supporting element half 17.

Fixing the inserted laminate 1, independently of the respective second half of a divided bearing can be particularly dangerous, for example, in the event repair work is necessary.

The present invention is not limited to the configurations heretofore described. Referring now to FIG. 5, a sliding shoe 18 is shown in which the laminate 1 is used on an essentially planar device.

The laminate 1, comprising the plastic film 2, the melting film 3 and the metal foil 4 or metal mesh, is adhesively attached to a sliding shoe 18 of a supporting element 17 by a suitable metal adhesive with the metal side on the sliding shoe 18. Two component epoxy resin adhesives are acceptable for the metal adhesive. The corresponding sliding surface may be covered by one or more pieces of laminate 1. The sliding bearing surface may be used in association with sliding shoes, segments, axial parts, should abutment surfaces, and the like.

The planar or slightly curved sliding bearing running surface is adhesively bonded with the laminate 1. The adhesive bonding is fixed by pressing on a planar or curved surface of a plate during the curving of the adhesive. After removing the fixing device, the laminate 1 has assumed the desired surface contour and is ready for use without any further subsequent work.

Thus, while there have shown and described and pointed out fundamental novel features of the invention as applied to preferred embodiments thereof, it will be understood that various omissions and substitutions and changes in the form ands details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A sliding bearing, comprising:
a housing having at least one running surface;
a laminate including a plastic layer, at least one metal layer and at least one melting layer, wherein the melting layer connects the plastic layer to the metal layer; and
an adhesive for adhering the metal layer of the laminate to the running surface.

2. The sliding bearing according to claim 1, wherein the laminate has a thickness up to about 2.0 mm, the plastic layer includes polytetrafluoroethylene (PTFE), and the metal layer is one of a metal foil and a metal mesh.

3. The sliding bearing according to claim 1, wherein the running surface is profiled in a splined form and the laminate has a splined profile corresponding to the profile of the running surface.

4. The sliding bearing according to claim 1, wherein the laminate is an electrical insulator and permits heat transfer from the running surface to the housing.

5. The sliding bearing according to claim 1, wherein the running surface comprises a sliding shoe.

6. A method for coating a running surface of a sliding bearing with plastic, comprising the sequential steps of:
forming at least one laminate having a metal surface and a plastic running surface by sequentially bonding together a plastic layer, at least one melting layer, and at least one of a metal foil and a metal mesh;
adhering the metal surface of the laminate to a bore formed in a first housing element using an adhesive;
inserting a shaft having a profile of a desired form of the bearing into the bore of the first housing element;
clamping the first housing element onto a second housing element so as to press the laminate against the bore using the shaft to form the desired shape of the laminate; and
releasing the clamping after the adhesive cures.

7. The method according to claim 6, wherein:
the inserting step includes inserting a semi-circular shaft having a substantially planar surface, the second housing element being formed as a plate.

8. The method according to claim 6, wherein the running surface possesses a curvature formed in the first supporting element, the inserting step includes inserting a shaft having a curvature corresponding to that of the running surface.

9. A method for coating a running surface of a sliding bearing with plastic comprising the sequential steps of:
forming at least one laminate having a metal surface and a plastic running surface by sequentially bonding together a plastic layer, at least one melting layer, and at least one of a metal foil and a metal mesh;
adhering the metal surface of the laminate to a surface of a supporting element using an adhesive;
pressing the laminate against the surface of the supporting element to form the desired shape of the laminate; and
releasing the pressing on the laminate after the adhesive cures.

10. The method according to claim 9, wherein the surface possesses a curvature, the pressing step being performed with a pressing member having a curvature corresponding to that of the surface.
